(19) United States
(12) Patent Application Publication
(10) Pub. No.: US 2007/0055968 A1
(43) Pub. Date: Mar. 8, 2007

(54) Reliable BIOS updates

(76) Inventor: Shawn T. Rader, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/221,675

(22) Filed: Sep. 7, 2005

(51) Int. Cl. G06F 9/44

(52) U.S. Cl. 717/168

(57) ABSTRACT

In one embodiment, a method is provided. The method of this embodiment provides receiving, at a network controller communicatively coupled to a non-volatile storage, a BIOS (Basic Input/Output System) update to replace a current BIOS, and using the network controller to write the BIOS update to the non-volatile storage.

### FIELD

Embodiments of this invention relate to reliable BIOS (Basic Input/Output System) updates.

### BACKGROUND

A common problem among system administrators and computer end users is determining a way to perform reliable updates of a system BIOS (Basic Input/Output System, hereinafter “BIOS”). BIOS updates may oftentimes result in problems with system performance, security, and stability. For example, if a BIOS update is interrupted, such as by a software hang, power loss, system reset, or user intervention, the system may be rendered useless. Furthermore, since a system must be able to boot to an operating system to perform a BIOS update, a BIOS update cannot be performed if the operating system is down.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system according to one embodiment.

FIG. 2 illustrates a network.

FIG. 3 is a flowchart illustrating a method according to one embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Briefly, an embodiment of the present invention relates to a computing platform having a network controller, a non-volatile storage, and a current BIOS stored on the non-volatile storage. In an embodiment, computing platform may comprise a managed client, and the network controller may receive a BIOS update from another computing platform, such as a management server, and may replace the current BIOS by writing the BIOS update to the non-volatile storage of the managed client. Furthermore, in an embodiment, the current BIOS may be saved to the management server prior to writing the BIOS update to the non-volatile storage.

BIOS refers to built-in software that determines what a computer can do without accessing programs. For example, BIOS may control the keyboard, display screen, disk drives, serial communications, and other miscellaneous functions.

“Managed client” as used herein refers to a computing platform having assets and/or resources that may be managed. “Management server” as referred to herein refers to a computing platform having management capabilities for managing a computing platform, such as a managed client. Management capabilities may include, for example, tracking a computing platform's assets, and performing remote functionalities, such as application updates and diagnostics.

A “network controller” as referred to herein relates to a device which may be coupled to a communication medium to transmit data to or receive data from other devices coupled to the communication medium, i.e., to send and receive network traffic. In an embodiment, the network controller may have an embedded microcontroller that that can access the BIOS and perform BIOS updates. Alternatively, network controller may have a hardware state machine designed to access the BIOS and perform BIOS updates.

For example, a network controller may transmit data to or receive data from devices coupled to a network such as a local area network. Such a network controller may communicate with the other devices according to any one of several data communication formats such as, for example, communication formats according to versions of IEEE Std. 802.3, IEEE Std. 802.11, IEEE Std. 802.16, Universal Serial Bus, Firewire, asynchronous transfer mode (ATM), synchronous optical network (SONET) or synchronous digital hierarchy (SDH) standards.

A “communication medium” as referred to herein relates to any media suitable for transmitting data. A communication medium may include any one of several mediums including, for example transmission cabling (e.g., coaxial, twisted wire pair or fiber optic cabling), wireless transmission media or power lines. However, these are merely examples of a communication medium and embodiments of the present invention are not limited in this respect.

“Non-volatile storage” as referred to herein relates to a storage medium capable of maintaining expressions of information when power is removed from the storage medium. Non-volatile storage may comprise, for example, writable optical media, magnetic media (e.g., hard disk memory) or semiconductor media (e.g., flash memory, EPROMs (Erasable Programmable Read Only Memory), or EEPROMs (Electrically Erasable Programmable Read Only Memory)). However, these are merely examples of a non-volatile storage and embodiments of the present invention are not limited in this respect. Devices communicating with a non-volatile storage may be capable of having “read access” to a portion of the non-volatile storage to retrieve information or having “write access” to store information in a portion of the non-volatile storage. BIOS may be stored in non-volatile storage.

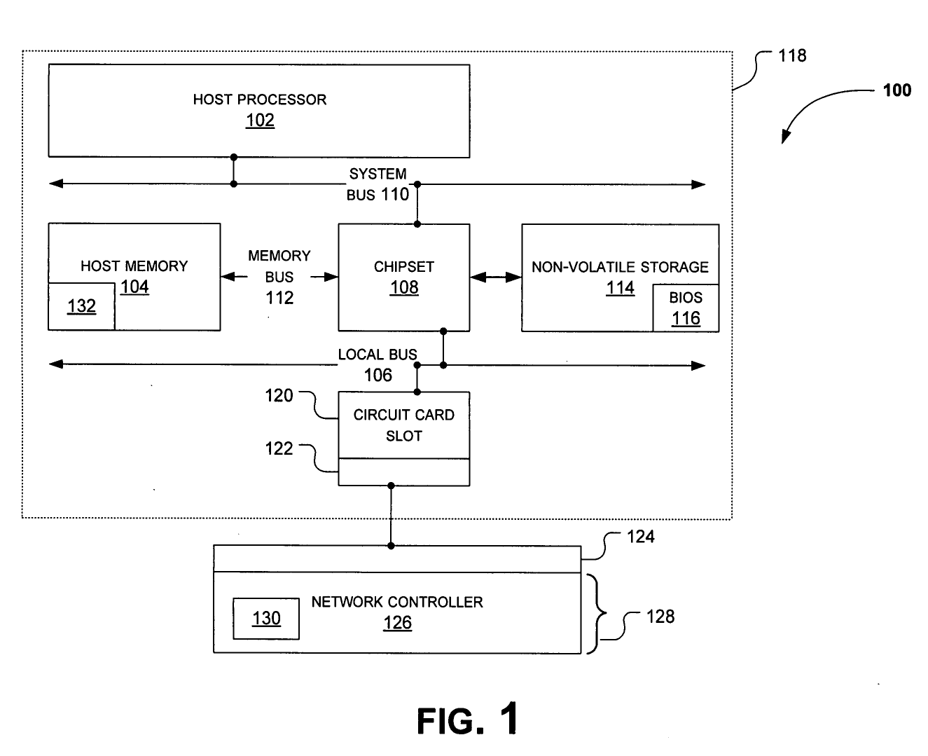

As illustrated in FIG. 1, computing platform 100 may comprise host processor 102 such as, for example, an Intel® Pentium® microprocessor that is commercially available from the Assignee of the subject application. Of course, alternatively, host processor 102 may comprise another type of microprocessor, such as, for example, a microprocessor that is manufactured and/or commercially available from a source other than the Assignee of the subject application, without departing from this embodiment.

Memory 104 may store machine-executable instructions 132 that are capable of being executed, and/or data capable of being accessed, operated upon, and/or manipulated by logic, such as logic 130. “Machine-executable” instructions as referred to herein relates to expressions which may be understood by one or more machines for performing one or more logical operations. For example, machine-executable instructions may comprise instructions which are interpretable by a processor compiler for executing one or more operations on one or more data objects. However, this is merely an example of machine-executable instructions and embodiments of the present invention are not limited in this respect. Memory 104 may, for example, comprise read only, mass storage, random access computer-accessible memory, and/or one or more other types of machine-accessible memories. The execution of program instructions 132 and/or the accessing, operation upon, and/or manipulation of this data by logic 130 for example, may result in, for example, system 100 and/or logic 130 carrying out some or all of the operations described herein.

Chipset 108 may comprise a host bridge/hub system that may couple host processor 102, and host memory 104 to each other and to local bus 106. Chipset 108 may comprise one or more integrated circuit chips, such as those selected from integrated circuit chipsets commercially available from the Assignee of the subject application (e.g., graphics, memory, and I/O controller hub chipsets), although other one or more integrated circuit chips may also, or alternatively, be used. According to an embodiment, chipset 108 may comprise an input/output control hub (ICH), although embodiments of the invention are not limited to this. For example, in one or more other embodiments, chipset 108 may comprise memory control hub (MCH) and ICH. Chipset 108 may communicate with memory 104 via memory bus 112 and with host processor 102 via host bus 110. In alternative embodiments, host processor 102 and host memory 104 may be coupled directly to bus 106, rather than via chipset 108.

Local bus 106 may be coupled to a circuit card slot 120 having a bus connector 122. Local bus 106 may comprise a bus that complies with the Peripheral Component Interconnect (PCI) Local Bus Specification, Revision 3.0, Feb. 3, 2004 available from the PCI Special Interest Group, Portland, Oreg., U.S.A. (hereinafter referred to as a “PCI bus”). Alternatively, for example, bus 106 may comprise a bus that complies with the PCI Express™ Base Specification, Revision 1.1, Mar. 28, 2005 also available from the PCI Special Interest Group (hereinafter referred to as a “PCI Express bus”). Bus 106 may comprise other types and configurations of bus systems.

Network controller 126 may be coupled to local bus 106. Network controller 126 may be comprised in a circuit card 128 (e.g., NIC or network interface card) that may be inserted into a circuit card slot 120. Network controller 126 may comprise logic 130 to perform operations described herein. Circuit card slot 120 may comprise, for example, a PCI expansion slot that comprises a PCI bus connector 122. PCI bus connector 122 may be electrically and mechanically mated with a PCI bus connector 124 that is comprised in circuit card 128. Circuit card slot 120 and circuit card 128 may be constructed to permit circuit card 128 to be inserted into circuit card slot 120. When circuit card 128 is inserted into circuit card slot 120, PCI bus connectors 122, 124 may become electrically and mechanically coupled to each other. When PCI bus connectors 122, 124 are so coupled to each other, logic 130 in circuit card 128 may become electrically coupled to host bus 110. Rather than reside on circuit card 128, network controller 126 may instead be comprised on system motherboard 118. Alternatively, network controller 126 may be integrated onto chipset 108.

Logic 130 may comprise hardware, software, or a combination of hardware and software (e.g., firmware). For example, logic 130 may comprise circuitry (i.e., one or more circuits), to perform operations described herein. Logic 130 may be hardwired to perform the one or more operations. For example, logic 130 may comprise one or more digital circuits, one or more analog circuits, one or more state machines, programmable logic, and/or one or more ASIC's (Application-Specific Integrated Circuits). Alternatively or additionally, logic 130 may be embodied in machine-executable instructions 132 stored in a memory, such as memory 104, to perform these operations. Alternatively or additionally, logic 130 may be embodied in firmware. In an embodiment, logic 130 may be comprised in a microcontroller of network controller 126. Alternatively, logic 130 may be comprised in a hardware state machine of network controller 126. In alternatively embodiments, logic 130 may be comprised in chipset 108 rather than network controller 130 as illustrated. In such embodiments, logic 130 in chipset 108 may communicate with network controller 130 via local bus 106.

Non-volatile storage 114 may store BIOS 116. As used herein, BIOS 116 refers to a current BIOS 116 that may be replaced by a BIOS update. In an embodiment, BIOS update may be sent from a management server. Chipset 108 and network controller 126 may have read and/or write access to non-volatile storage 114. Non-volatile storage 114 may be communicatively coupled to chipset 108, and may be accessed by network controller 126 via chipset 108. In an embodiment, chipset 108 may be communicatively coupled to non-volatile storage 114 using defined hardware interfaces in chipset 108 to non-volatile storage 114. Alternatively this may be via an SPI (Serial Peripheral Interface) bus implemented in the chipset 108. SPI bus is a serial synchronous interface for connecting low speed devices using minimal number of wires. Alternatively, non-volatile storage 114 may be communicatively coupled to network controller 126, and may be accessed by chipset 108 via network controller 126. In such an embodiment, network controller 126 may be communicatively coupled to non-volatile storage 114 using defined hardware interfaces in network controller 126 to non-volatile storage 114. As used herein, components that are “communicatively coupled” means that the components may be capable of communicating with each other via wirelined (e.g., copper or optical wires), or wireless (e.g., radio frequency) means.

System 100 may comprise more than one, and other types of memories, buses, and network controllers; however, those illustrated are described for simplicity of discussion. Host processor 102, memory 104, and busses 106, 110, 112 may be comprised in a single circuit board, such as, for example, a system motherboard 118, but embodiments of the invention are not limited in this respect.

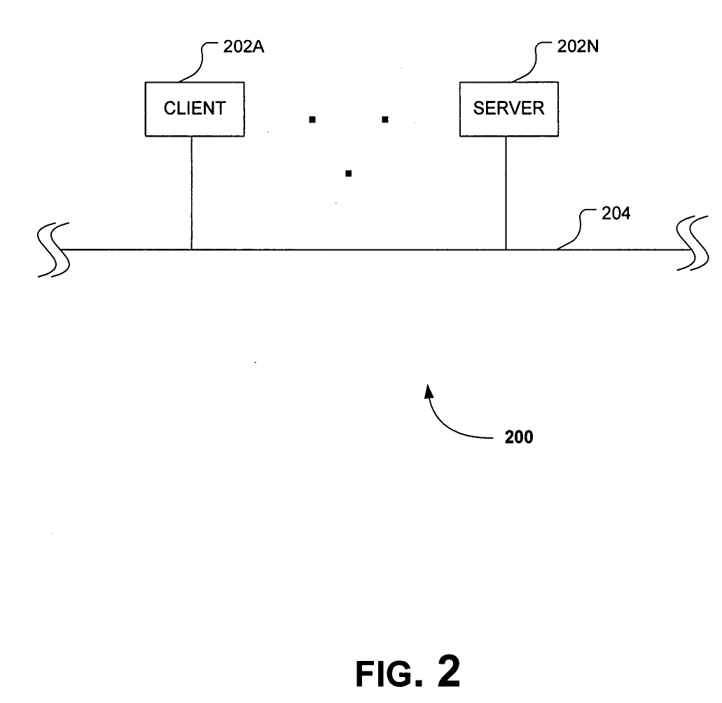

As shown in FIG. 2, system 100 may operate in a network 200. Network 200 may comprise a plurality of nodes 202A, . . . 202N, and one or more nodes (e.g., 202A) may comprise system 100. In an embodiment, one of nodes 202A, . . . , 202N may comprise a managed client, and another of nodes 202A, 202N may comprise a management server. Also, one or more of the nodes 202A . . . 202N may comprise one or more intermediate stations (not shown), such as, for example, one or more hubs, switches, and/or routers; additionally or alternatively, one or more of the nodes 202A . . . 202N may comprise one or more end stations.

Furthermore, nodes 202A, . . . , 202N may be communicatively coupled together via a communication medium 204. Communication medium 204 may communicatively couple together at least some of the nodes 202A . . . 202N and one or more of these intermediate stations. Of course, many alternatives are possible.

Furthermore, nodes 202A . . . 202N may transmit and receive sets of one or more signals via communication medium 204 that may encode one or more packets. As used herein, a “packet” means a sequence of one or more symbols and/or values that may be encoded by one or more signals transmitted from at least one sender to at least one receiver. For example, a managed client may send the current BIOS via packets, and the management server may send a packet comprising the BIOS update, and/or may send a specially formatted packet that may comprise an indication of a BIOS update.

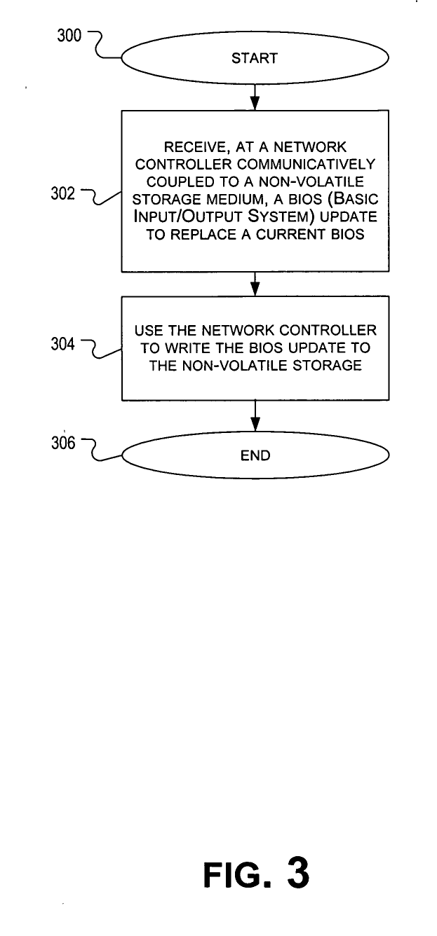

A method according to an embodiment is illustrated in FIG. 3. The method of FIG. 3 begins at block 300 and continues to block 302 where the method may comprise receiving, at a network controller communicatively coupled to a non-volatile storage, a BIOS (Basic Input/Output System) update to replace a current BIOS. For example, network controller 126 may be communicatively coupled to non-volatile storage 114. Network controller 126 may receive a BIOS update to replace a current BIOS 116.

In an embodiment, the BIOS update may be received in response to receiving a packet that indicates the BIOS update is available. In an embodiment, a specially formatted packet may comprise, for example, an Ethernet packet directed to a MAC (media access control) address of the network controller 126. The packet may contain a signature informing the network controller 126 that a BIOS update is available, as well as the size of the packet, and security/authentication information.

Logic 130 may detect reception of this packet. Upon receiving notification of an available BIOS update, logic 130 may send an acknowledgement Ethernet packet to the management server through network controller 126. When the management server receives the acknowledgement, it may begin transmission of the BIOS update to network controller 126. As packets are received by network controller 126, they may be redirected to logic 130 in accordance with the specially formatted packet. Logic 130 may transfer the one or more packets to host memory 104 for temporary storage. In an embodiment, one or more packets may be transferred using direct memory access methods, e.g., via PCI. As used herein, “transfer” refers to movement from a source to a destination. Movement may be by redirection, or by copy, for example.

At block 304, the method may comprise using the network controller to write the BIOS update to the non-volatile storage. For example, network controller 126 may be used to write the BIOS update to non-volatile storage 114. In an embodiment, logic 130 may transfer BIOS update from host memory 104 to non-volatile storage 114 upon receipt at host memory 104 of BIOS update. In an embodiment, this transfer may not occur until host memory 104 is in receipt of entire BIOS update. In an embodiment where chipset 108 is communicatively coupled to non-volatile storage 114, logic 130 may transfer data from host memory 104 to chipset 108 via memory bus 112, and from chipset 108 to non-volatile storage 114 via defined hardware interfaces. In an alternatively embodiment where network controller 126 is communicatively coupled to non-volatile storage 114, logic 130 may transfer data from host memory 104 to chipset 108 via memory bus 112, from chipset 108 to network controller 126 via local bus 106, and from network controller 126 to non-volatile storage 114 via defined hardware interfaces.

In an embodiment, the method may additionally comprise making a back-up copy of the current BIOS prior to the network controller writing the BIOS update to the non-volatile storage. For example, the current BIOS 116 may be sent over a communication medium (e.g., 204) to a management server, and stored there for safekeeping. If, for example, the BIOS update does not install correctly, or is corrupted, the back-up BIOS (i.e., current BIOS 116) may be restored.

In an embodiment, the method may additionally comprise restarting writing the BIOS update if the network controller's write of the BIOS update to the non-volatile storage is unsuccessful. For example, if the BIOS update is interrupted by a power loss, network controller 126 may inform management server, and management server may resend the BIOS update.

The method may end at block 306.

### CONCLUSION

Therefore, in one embodiment, a method may comprise receiving, at a network controller communicatively coupled to a non-volatile storage, a BIOS (Basic Input/Output System) update to replace a current BIOS, and using the network controller to write the BIOS update to the non-volatile storage.

Embodiments of the invention may provide a safe BIOS update mechanism. Using a network controller to perform BIOS updates, BIOS updates may be resent and rewritten if BIOS updates are interrupted. Furthermore, BIOS updates may be performed without relying on the ability of the system to boot to an operating system. Embodiments of the invention may additionally enable BIOS updates to be pushed remotely, such as by an IT (information technology) administrator, and may also eliminate the need for boot disks.

In the foregoing specification, the invention has been described with reference to specific embodiments thereof. It will, however, be evident that various modifications and changes may be made to these embodiments without departing therefrom. For example, microcontroller may be embedded in a chipset (such as a ICH) rather than a network controller. In such embodiments, network controller and microcontroller may communicate over a local bus, such as a PCI bus to receive network traffic. The specification and drawings are, accordingly, to be regarded in an illustrative rather than a restrictive sense.

What is claimed is:

1. A method comprising:
receiving, at a network controller communicatively coupled to a non-volatile storage, a BIOS (Basic Input/Output System) update to replace a current BIOS; and
using the network controller to write the BIOS update to the non-volatile storage.

2. The method of claim 1, wherein said receiving the BIOS update is in response to receiving a packet that indicates the BIOS update is available.

3. The method of claim 1, additionally comprising making a back-up copy of the current BIOS prior to writing the BIOS update to the non-volatile storage.

4. The method of claim 1, additionally comprising restarting said using the network controller to write the BIOS update if said using the network controller to write the BIOS update to the non-volatile storage is unsuccessful.

5. An apparatus comprising:
logic in a network controller to:
receive, at a network controller communicatively coupled to a non-volatile storage, a BIOS (Basic Input/Output System) update to replace a current BIOS; and
use the network controller to write the BIOS update to the non-volatile storage.

6. The apparatus of claim 5, wherein said receiving the BIOS update is in response to receiving a packet that indicates the BIOS update is available.

7. The apparatus of claim 5, additionally comprising making a back-up copy of the current BIOS prior to writing the BIOS update to the non-volatile storage.

8. The apparatus of claim 5, additionally comprising restarting said using if said using the network controller to write the BIOS update to the non-volatile storage is unsuccessful.

9. The apparatus of claim 5, wherein the logic is comprised in a microcontroller.

10. A system comprising:
an EPROM (erasable programmable read only memory); and
a network controller communicatively coupled to the EPROM to:
receive a BIOS (Basic Input/Output System) update; and
write the BIOS update to the EPROM.

11. The system of claim 10, wherein the BIOS update is received from a management server.

12. The system of claim 11, additionally comprising making a back-up copy of the current BIOS prior to writing the BIOS update to the non-volatile storage.

13. The system of claim 12, wherein said making a back-up copy of the current BIOS prior to writing the BIOS update to the non-volatile storage comprises transmitting the current BIOS to a management server.

14. The system of claim 10, wherein said receiving the BIOS update is in response to receiving a packet that indicates the BIOS update is available.

15. The system of claim 10, additionally comprising restarting said using the network controller to write the BIOS update if said using the network controller to write the BIOS update to the non-volatile storage is unsuccessful.

16. An article comprising a machine-readable medium having machine-accessible instructions, the instructions when executed by a machine, result in the following:
receiving, at a network controller communicatively coupled to a non-volatile storage, a BIOS (Basic Input/Output System) update to replace a current BIOS; and
using the network controller to write the BIOS update to the non-volatile storage.

17. The article of claim 16, wherein said receiving the BIOS update is in response to receiving a packet that indicates the BIOS update is available.

18. The article of claim 16, additionally comprising making a back-up copy of the current BIOS prior to writing the BIOS update to the non-volatile storage.

19. The article of claim 16, additionally comprising restarting said using the network controller to write the BIOS update if said using the network controller to write the BIOS update to the non-volatile storage is unsuccessful.
